(19) United States
(12) Patent Application Publication
(10) Pub. No.: US 2017/0121993 A1
(43) Pub. Date: May 4, 2017

(54) SWIM IN PLACE POOL/SPA

(71) Applicant: HYDROPOOL INC., Mississauga (CA)

(72) Inventor: Douglas Robert WYATT, Beamsville (CA)

(21) Appl. No.: 15/258,746

(22) Filed: Sep. 7, 2016

Related U.S. Application Data
(60) Provisional application No. 62/249,457, filed on Nov. 2, 2015.

(51) Int. Cl. E04H 4/12; A63B 69/12; G05D 7/06

(52) U.S. Cl. CPC E04H 4/12; G05D 7/0676; A63B 69/125; A63B 2208/03

(57) ABSTRACT

The swim in place pool can have a basin for receiving water therein, the basin having a rear end and a front end and being adapted to receive a swimming user; at least one circulation subsystem having: a primary conduit, a circulation conduit leading to a circulation outlet located at the front end of the basin, a diverter conduit having a diverter outlet, a pump operable to pump water from the primary conduit inlet, a diverter valve connecting the primary conduit to both the circulation conduit and the diverter conduit and having a valve actuator operable to adjust the relative ratio of the water pumped from the primary conduit inlet between the circulation conduit and the diverter conduit; and a controller connected to control the valve actuator and having a user interface accessible to the swimming user in the basin.

### REFERENCE TO RELATED APPLICATIONS

This patent application claims priority of U.S. provisional Application Ser. No. 62/249457 filed Nov. 2, 2015, the contents of which are hereby incorporated by reference.

### FIELD

The improvements generally relate to the field of swim in place pools, and more specifically to the systems for controlling the circulating flow rate of water.

### BACKGROUND

Swim in place pools (including swim-spas) have a water circulation system which pumps water from one end (front) of the basin to the other end (rear) of the basin, thus generating a flow such as a river in which the user can swim without moving relative to a land reference. Using such systems, the user can swim in an uninterrupted manner in a relatively small volume of water. Indeed, by swimming at the speed of the flow of water, the user can stay in place as he/she swims. Different users have different preferences in terms of swimming speeds. For instance, some users may prefer casual swimming whereas others can prefer swimming at a higher intensity. The swimming speed is directly related to the speed of the water in the basin. It was known to provide water circulation systems which allowed more than one speed of water, so as to be adaptable to various user preferences. Although known systems were satisfactory to a certain degree, there remained room for improvement. In particular, the operation of adjusting the speed was uncomfortable, burdensome or strenuous to the user.

### SUMMARY

There is provided a swim-in-place pool where the user can casually adjust the speed of the water flow while he/she is swimming.

In accordance with one aspect, there is provided a water circulation system in which the speed of the water flow in the basin can be adjusted by diverting some of the circulation water from the front outlets to lateral outlets which do not contribute to the speed of the water in the basin to the same extent that the front outlets do. The adjustment of the ratio of diverted water/circulated water can be performed via motorized valves, i.e. valves that have electronically-controllable valve actuators. The diversion valve actuators can be electronically controlled by a user interface. In one embodiment, the user interface is provided with touch sensors (e.g. capacitive sensors, pressure sensors, press-switches . . . ) which are exposed to the interior of the basin in a manner that the user can control the diversion valve actuators, and thus adjust the speed of the water, while he/she is swimming, which can lead to a satisfying and comfortable user experience.

In accordance with another aspect, there is provided an automatic water diversion system for a swim in place pool which allows for automatic adjustments from incremental increases or decreases, where adjustment of the diversion actuator is done remotely from the actuator. The system can allow satisfactory water flow performance and balanced water flow from side to side of the swim in place pool.

In accordance with another aspect, there is provided a swim in place pool comprising: a basin for receiving water therein, the basin having a rear end and a front end and being adapted to receive a swimming user; at least one circulation subsystem having: a primary conduit extending from an inlet located at the rear end of the basin, a circulation conduit leading to a circulation outlet located at the front end of the basin and configured to create a swimming flow in the basin with the primary conduit inlet, a diverter conduit having a diverter outlet leading into the basin, a pump operable to pump water from the primary conduit inlet, a diverter valve connecting the primary conduit to both the circulation conduit and the diverter conduit and having a valve actuator operable to adjust the relative ratio of the water pumped from the primary conduit inlet between the circulation conduit and the diverter conduit; and a controller connected to control the valve actuator and having a user interface accessible to the swimming user in the basin.

In accordance with one aspect, there is provided a swim in place pool comprising: a basin for receiving water therein, the basin having a rear end and a front end and being adapted to receive a swimming user; at least one circulation subsystem having: a primary conduit extending from an inlet located at the rear end of the basin, a circulation conduit leading to a circulation outlet located at the front end of the basin and configured to create a swimming flow in the basin with the primary conduit inlet, a diverter conduit having a diverter outlet leading into the basin, a pump operable to pump water from the primary conduit inlet, a diverter valve connecting the primary conduit to both the circulation conduit and the diverter conduit and having a valve actuator operable to adjust the relative ratio of the water pumped from the primary conduit inlet between the circulation conduit and the diverter conduit; and a controller connected to control the valve actuator and having a user interface accessible to the swimming user in the basin.

In accordance with another aspect there is provided an automatic water diversion system for a swim in place pool including a water circulating system having at least two outlets that open into the swim in place pool. The diversion system includes at least two electronic adjustable valve actuators positioned remotely from the top surface of the swim in place pool. The adjustable valve actuators that have a series of diverters. The electronic adjustable valve actuators may be in communication with the water circulating system thereby allowing for incremental adjustments of water flow between the adjustable valve actuators and between the two outlets.

The water circulating system can include at least two pumps and a series of conduits. The pumps may be positioned outside and remotely from the top surface of the swim in place pool and the conduits connect the pumps and the outlets.

The diversion system may further include an electronic control system having an activation and deactivation display. The electronic control system may be adapted to activate and rotate the diverters of the adjustable valve actuators remotely by user. The electronic control system may be enabled to communicate remotely, via a wired or wireless (e.g. W-Fi) connection, with the adjustable valve actuators activating and rotating the diverters to adjust the water flow through the water circulating system thereby adjusting the water flow through the outlets. This action may be achieved by the user or swimmer pressing a button while swimming.

The electronic adjustable valve actuators may include a diverter body, a series of cams, upper and lower, that engage within the actuators, a diverter cap and a diverter handle. Conveniently the cams may be positioned so as to be pre-set within the electronic adjustable valve actuators.

Conveniently, the automatic water diversion system may allow for manipulation of the adjustable valve actuators and specifically the diverters, without requiring manual operation of the valves.

In accordance with one embodiment, the user can make incremental increases or decreases in the flow of the water by using a touch display that is positioned remotely from the adjustable valve actuator. The swimmer can make easy adjustments to the water speed or current at a touch of a button so that it suits their individual needs and their fitness level. Given the specificities of some embodiments, where potentially flow-restricting features such as heaters are provided in the circulation system, the mechanical work required to adjust the diverter valves during operation, which typically involves overcoming the water pressure and velocity to change the water flow, can be significant. The mechanical work of adjusting the diverter can be performed by the electronically controlled valve actuator. Moreover, when dual swim jets are used (i.e. twin circulation and diverter conduits), the use of electronically controlled valve actuators can help maintaining flow balance during operation.

Many further features and combinations thereof concerning the present improvements will appear to those skilled in the art following a reading of the instant disclosure.

### DESCRIPTION OF THE FIGURES

In the figures,

FIG. 1 is an oblique view of a first example of a swim in place pool with a water flow system;

FIG. 2 is a front elevation view of the swim in place pool of FIG. 1;

FIG. 3 is an exploded side view of a diverter valve, without the actuator, of the swim in place pool of FIG. 1;

FIG. 4 is a side view of an actuator of the swim in place pool of FIG. 1; and

FIG. 5 is a user interface of the swim in place pool of FIG. 1.

### DETAILED DESCRIPTION

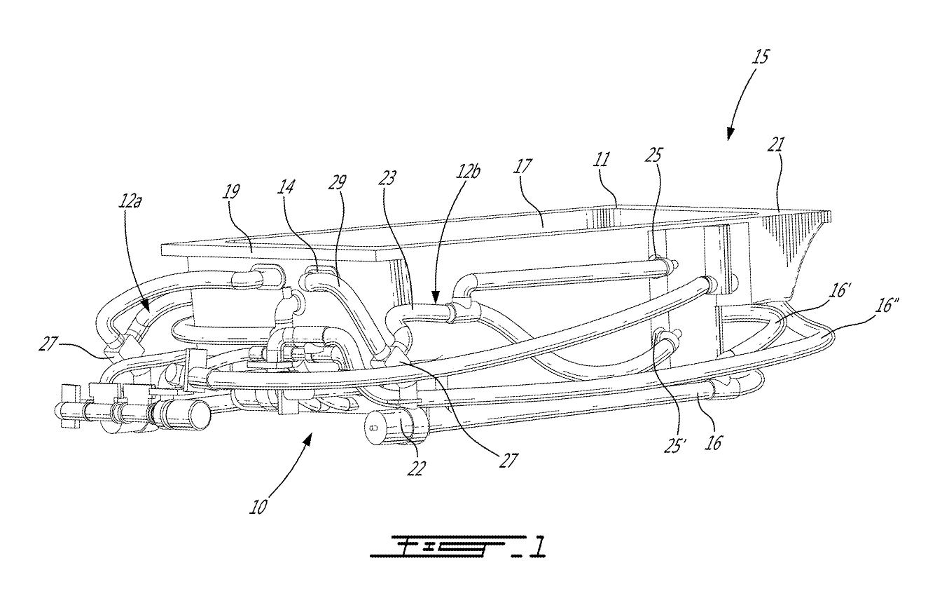

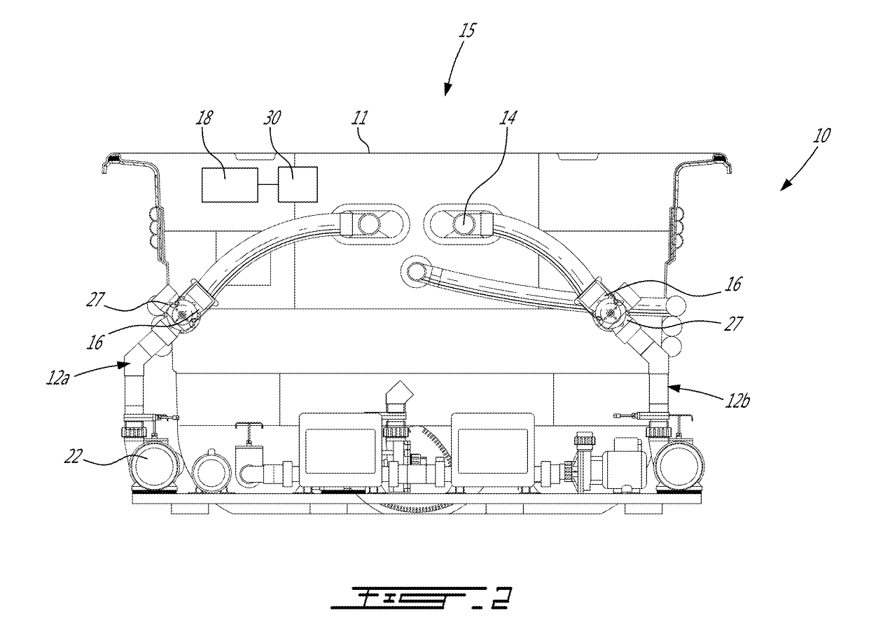

FIGS. 1 and 2 show an example embodiment of a swim in place pool 15 with an automatic water diversion system 10. The swim in place pool 15 has a basin 17 having a top surface 11. In this embodiment, the automatic water diversion system 10 includes a pair of water circulation subsystems 12a, 12b. One water circulation subsystem 12a, 12b is provided on each side of the swim in place pool. In this embodiment, the water circulation subsystem 12a, 12b both have the same elements, and so only one will be described in detail. The water circulation subsystem 12b has at least one circulation outlet 14 that opens into the swim in place pool 15, and more specifically at the front end 19 of the basin. The water circulation subsystem 12b has its own dedicated recirculation pump 22 adapted to pump water into the inlet (not shown) of a primary conduit 16 from the rear end 21 of the basin 17. In this embodiment, the primary conduit 16 has two branches 16′, 16″ manifolding two respective sub-inlets into a common conduit leading to the recirculation pump 22. The water circulation subsystem 12b further has a diverter conduit 23 leading to a bypass outlet 25, 25′ in the basin. In this embodiment, the diverter conduit also branches off and has to two bypass sub-outlets 25, 25′. The water circulation subsystem 12b has a diverter valve 27 connecting the primary conduit 16 to both the diverter conduit 23 and a circulation conduit 29 leading to the circulation inlet 14.

Operation of the diverter valve 27 allows to adjust the relative flow rate of water which is diverted from the circulation conduit 29 to the diverter conduit 23, so as to adjust the speed of the water flow in the basin. The circulation outlets 14 at the front end 19, and the inlets at the rear end 21, are directed substantially towards one another in the longitudinal orientation to cooperate in imparting the speed of the water flow in the basin 17. Contrary to the circulation outlet 14 which is aimed longitudinally, the bypass outlet 25, 25′ is aimed laterally and does not contribute significantly to the speed of the water flow in the basin 17. The diverter valves 27 have valve actuators 16 which are electronically controlled by a controller 18, such as shown in FIG. 2. A user interface 30 is provided in a manner to be accessible by a swimming user in the basin 17, such as on a top portion 11 of the basin above the water line, for instance. Accordingly, the controller 18 can adjust the speed of the water in the basin, based on the swimming user's input received via the user interface 30, by controlling the valve actuators 16. In this embodiment, the pumps 22 are positioned outside and remotely from the top surface 11 of the swim in place pool 15. The pumps 22 are connected between the inlet and the outlets 14, 25 by the conduits 16, 29, 23, 25. The circulation outlets 14 can be wide stream jets and the bypass outlets 25, 25′ can be located at an intermediary location along the side of the swim in place pool, on opposite lateral sides, and designed so as to engage the user's thigh. The valve actuators 16 are distant from the top surface 11 and are not directly accessible by the user. The controller 18, via the user interface 30 and valve actuators 16, allows for incremental adjustments of water diversion between the circulation conduit 29 and the diversion conduit 23. For instance, the user interface may include a key pad including a ‘faster’ key, or ‘up’ key 32, and a ‘slower’ key, or ‘down’ key 34, for instance, that may be engaged by the user to increase or decrease the speed of the water in the basin, respectively, such as shown in FIG. 5.

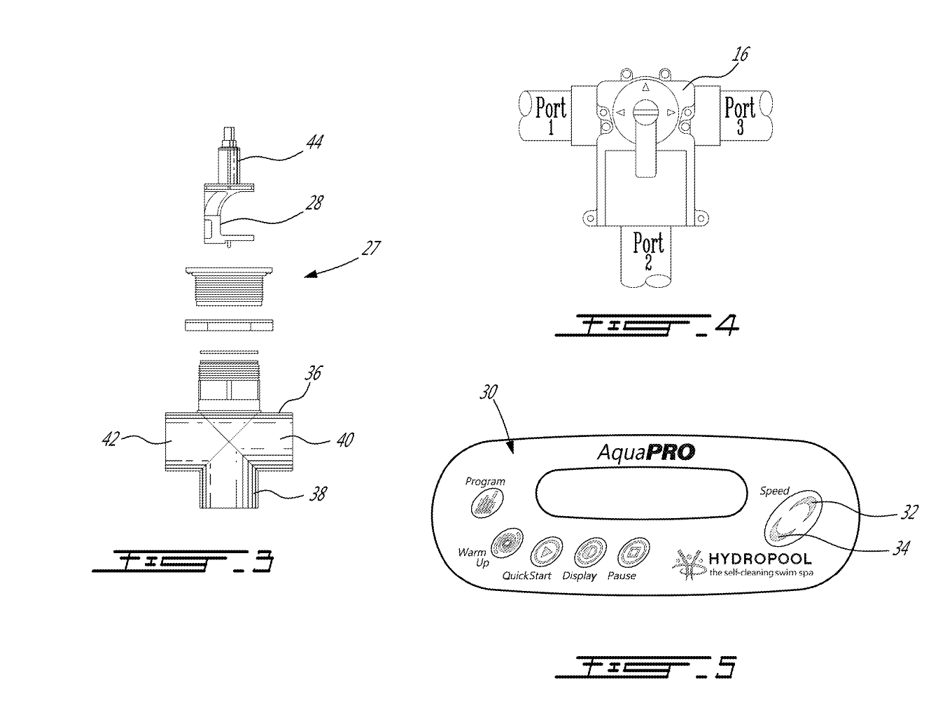

An example of a diverter valve 27 is shown in FIG. 3. The diverter valve 27 has a fixed diverter body 36 having an inlet 38 and two outlets 40, 42, and a valve member 28 rotatably mounted in the diverter body 36. The valve member 28 has an upper cam and a lower cam, and its rotation controls the relative amount of flow rate being directed to the two outlets 40, 42. A stem 44 protrudes from the valve member 28. The valve actuator 16 (shown in FIG. 4) is mounted to the stem 44 to control the rotation.

An example of a valve actuator 16 is shown in FIG. 4. In this example, the valve actuator is model GVA-24 valve actuator sold under the trademark Hayward, and was found to provide satisfactory operation. Alternate valve actuators can be used in alternate embodiments.

In the example embodiment, the operation of the automatic water diversion system 10 for a swim in place pool 15 includes activating the pumps 22 of the water circulating subsystems 12a, 12b in a synchronized manner using the controller 18. The user may then adjust the automatic water diversion system 10 and specifically the flow rate of water through the circulation outlets 14. This can be achieved by the user engaging a key pad forming part of the user interface 30, and located remotely from the electronic adjustable valve actuators 16, and pressing an up 32 or a down 34 arrow, for instance. Depressing the key pad results in the electronic adjustable valve actuators 16 rotating the valve members 28 in accordance with the user's input.

The user has the ability to remotely adjust the flow rate through the outlets 14 by just pressing a key pad, which can conveniently be done while he/she is engaged in the swimming activity. The user has to exert very little pressure in pushing the key pad button to overcome the significant force being exerted on the diverters 18 when the swim in place pool pumps 22 are engaged and the water is being pumped through the water circulating system 12. Furthermore the automatic water diversion system 10 for a swim in place pool 15 can allow for 100 percent diversion of the water from the midpoint jet outlet 25, 25′ to the wide stream jet outlet 14. This may be conveniently accomplished without the user having to exert any significant effort or pressure. The ability to divert such dramatically large volumes of water allows for the water flow to be completely customized by the user to accommodate different levels and skills of swimmers.

Other variations and modifications of the invention are possible. For instance, in the embodiment illustrated, it was preferred to use two independent pumps and each associated to a corresponding one of two independent circulation subsystems. In alternate embodiments, it would be possible to use only a single circulation subsystem and only a single pump, for instance. Alternately, it would be possible to use more than two circulation subsystems. Each circulation subsystem could use more than one pump, could have more than one inlet, more than one circulation outlet, and/or more than one diversion outlet, for instance, especially in a context where it may be advantageous to merge and re-separate flow, such as to uniformize flow rate for instance. The pumps can be variable speed pumps, but this was not found essential in the embodiment described above. The controller can be connected to control and operate the valve actuators in a wired or wireless manner. Similarly, the controller can be connected to the user interface in a wired or wireless manner. The controller, or electronic control system, may be contained or associated with a housing structure adjacent the swim in place pool. In alternate embodiments, the controller can be embodied in various forms. For instance, the controller can alternately be embodied as an application stored in the memory of a smart phone, for instance. In the illustrated embodiment, the controller is housed in a waterproof housing made integral to the basin. Accordingly, as can be understood, the examples described above and illustrated are intended to be exemplary only. The scope is indicated by the appended claims.

What is claimed is:

1. A swim in place pool comprising:
a basin for receiving water therein, the basin having a rear end and a front end and being adapted to receive a swimming user;
at least one circulation subsystem having:
a primary conduit extending from an inlet located at the rear end of the basin,
a circulation conduit leading to a circulation outlet located at the front end of the basin and configured to create a swimming flow in the basin with the primary conduit inlet,
a diverter conduit having a diverter outlet leading into the basin,
a pump operable to pump water from the primary conduit inlet,
a diverter valve connecting the primary conduit to both the circulation conduit and the diverter conduit and having a valve actuator operable to adjust the relative ratio of the water pumped from the primary conduit inlet between the circulation conduit and the diverter conduit; and
a controller connected to control the valve actuator and having a user interface accessible to the swimming user in the basin.

2. The swim in place pool of claim 1 comprising at least one pair of two of said at least one circulation subsystems, wherein said controller is connected to control the valve actuator of each one of said at least two circulation subsystems in a synchronized manner based on a single input received from the swimming user via the user interface.

3. The swim in place pool of claim 1 wherein the diverter outlets are provided on opposite lateral sides of the basin.

4. The swim in place pool of claim 3 comprising at least two diverter outlets provided on each one of the two opposite lateral sides of the basin.

5. An automatic water diversion system for a swim in place pool having a top surface, comprising:
(a) a water circulating system having at least two outlets that open into the swim in place pool;
(b) at least two electronic adjustable valve actuators positioned remotely from the top surface of the swim in place pool, the electronic adjustable valve actuators having a series of diverters, the electronic adjustable valve actuators in communication with the water circulating system allowing for incremental adjustments of water flow between the electronic adjustable valve actuators and between the two outlets; and
(c) an electronic control system having an activation and deactivation display and adapted to activate and rotate the diverters of the electronic adjustable valve actuators remotely;
where upon activation of the electronic control system, the electronic control system remotely communicates with the electronic adjustable valve actuators activating and rotating the diverters to adjust the water flow through the water circulating system thereby adjusting the water flow through the outlets.

6. An automatic water diversion system for a swim in place pool as claimed in claim 5 wherein the water circulating system comprises at least two pumps and a series of conduits wherein the pumps are positioned outside and remotely from the top surface of the swim in place pool and the conduits connect the pumps and the outlets.

7. An automatic water diversion system for a swim in place pool as claimed in claim 6 wherein the outlets are a wide stream jet outlet and a midpoint jet.

8. An automatic water diversion system for a swim in place pool as claimed in claim 7 wherein the electronic adjustable valve actuators are a series of diverters in communication with the water circulating system thereby allowing for incremental adjustments of water flow between the electronic adjustable valve actuators and between the two outlets.

9. An automatic water diversion system for a swim in place pool as claimed in claim 8 wherein the diverters further comprise a diverter body, a series of cams for engagement within the electronic adjustable actuators, a diverter cap and a diverter handle.

10. An automatic water diversion system for a swim in place pool as claimed in claim 8 wherein the activation and deactivation display is a key pad positioned on the top surface of the swim in place pool to increase or decrease the flow of the water from either the wide stream jet outlet or the midpoint jet outlet.
